(19) United States
(12) Patent Application Publication
(10) Pub. No.: US 2003/0061089 A1
(43) Pub. Date: Mar. 27, 2003

(54) Method and apparatus for a staffing application server

(76) Inventor: Kevin Weaver, Flower Mound, TX (US)

Correspondence Address: James A. Harrison, Garlick Harrison & Markison, P.O. Box 670007, Dallas, TX, 75367, US

(21) Appl. No.: 09/962,053

(22) Filed: Sep. 24, 2001

(51) Int. Cl. G06F 17/60

(52) U.S. Cl. 705/9

(57) ABSTRACT

The present invention includes a staffing application server and a method therefore that facilitates the placement of short-term staffing personnel to fill short-term staffing job postings. The present invention further may be used to fill long term job assignments. The SAS is coupled to a World Wide Web such as the Internet and allows employers and personnel to enroll. After enrolling, the employers may post short-term or long-term jobs and staffing personnel may post specified work conditions, including shift assignments and corresponding compensation. In particular, the SAS system enables staffing personnel to specify different levels of compensation according to the shift he or she might work.

### CROSS REFERENCE TO RELATED APPLICATIONS

This application incorporates by reference, and claims priority to, a U.S. Provisional Application for Patent filed on Sep. 22, 2000, and having a serial no. of 60/______ and a title of METHOD AND APPARATUS FOR A STAFFING APPLICATION SERVER. The one year anniversary of the filing date of said provisional fell on a Saturday thereby extending the deadline to file this utility application to Sep. 24, 2001.

### BACKGROUND

1. Technical Field

The present invention relates to systems and methods for assisting in employment scheduling and, more specifically, to those systems that facilitate the rapid location and selection of available, qualified and willing short-term employees.

2. Related Art

One of the hottest topics of national debate today is the increasing cost associated with the healthcare industry, one of the primary factors being the increasing cost of access to qualified nurses. The recently publicized nurse shortage is now gaining greater attention due to the aging population of nurses, the decrease of enrollment in nursing schools and the ever-increasing demand for nurses—a demand that rose by 23 percent in 1999 alone. This shortage is predicted to continue to increase through 2005.

Healthcare systems are currently suffering from enormous and staggering financial burdens caused in part by the need to access qualified nurses to meet their daily needs. The industry has sought to decrease costs in the past by lowering pay to nurses and decreasing numbers of core staff. This decision has caused an exodus of nurses from permanent positions in hospitals to higher paying, more flexible positions with temporary staffing agencies thus creating the necessity for more temporary staff to fill voids when patient levels are near or above normal. Healthcare facilities are now using temporary staffing agencies and expensive recruiting companies for permanent staff. In many cases, temporary staff has become the rule, not the exception. Temporary staffing agencies are expensive alternatives to what many hospital personnel believe is a problem that is beyond the crisis status. Some facilities spend as much as $1M per month for temporary nursing staff alone.

The most costly component associated with operating a traditional temporary staffing agency is the cost of funding nurse payroll. Typically, nurses are paid weekly and/or daily, while hospitals are billed monthly and often pay on a thirty-to-sixty-day cycle. In the interim, the traditional staffing agency must float the cost of nurse payroll. The cost of floating this money can be excessive whether factored or debt-financed. In the event a traditional staffing agency is financially liquid and can self-fund nurse payroll, a non-payment can create substantial losses.

Effectively managing a traditional temporary staffing agency is very labor intensive. To staff one shift with a traditional approach requires several phone calls. In a is typical scenario, a call is made to a hospital to establish a need, and then a variable number of calls are made to the available list of nurses. Next, another call is placed back to the facility to confirm the need still exists and, finally, one more call is made to the nurse to confirm the shift is still available. It is also common for shifts to be cancelled with little notice, requiring an additional call to the nurse. Most staffing coordinators manage between 150 to 200 phone calls per day. These positions are staffed 24 hours per day, seven days per week. Internal staff burnout is extremely high in these positions.

Recruiting and maintaining competent staff skilled enough to manage the stresses created by this volume of activity and that are willing to work at an “unskilled” pay rate is difficult. This causes a tremendous amount of internal staff turnover and interruptions in providing consistent quality service.

Nurse recruitment is highly competitive in the current market shortage. Pay has now become the greatest incentive to attract nurses to temporary positions, which can directly affect a staffing agency's gross profit margin. Additionally, nurses typically forgo medical and retirement benefits associated with core staff positions in order to obtain higher wages. This process is prompting hospitals to offer higher hourly rates and a cash-signing bonus for nurses, thereby making it increasingly difficult for temporary companies to recruit nurses.

Nurse loyalty is highly competitive in a market shortage. Nurses are gravitating toward organizations offering the highest signing bonuses and pay. Furthermore, nurses are participating only long enough to receive the cash incentives and then considering other options.

Most hospitals consider temporary staffing agencies as a necessary evil. They are viewed for the most part as costly and undependable and therefore are used only as a last resort. It is not uncommon for a hospital to maintain 20 to 30 contracts with different temporary staffing agencies even though dealing with such agencies is costly and often inefficient and frustrating because the alternative of having potentially too many employees on the payroll also is undesirable. Loyalty has now become based on cost, size and the dependability of the staffing agency's existing pool. These factors are difficult for a staffing agency to control its ability to recruit and keep staffing personnel in the current market, resulting in decreased hospital loyalty.

Current market trends make it necessary for most hospitals to maintain internal staffing coordinators to manage nurses sourced from temporary staffing agencies. In-house staffing coordinators must manage fluctuating demands in daily hospital census with the hospital's own temporary pool of nurses, and then interface with the various temporary staffing agencies. This procedure adds additional soft costs associated with a hospital's choice to use a traditional staffing agency. y What is needed, therefore, is a method and apparatus for facilitating nurse assignment and staffing of nurses in a manner that enables nurses to obtain top pay while providing reliability, ease of use and efficiency to the staffing agencies and hospitals.

### SUMMARY OF THE INVENTION

To overcome the shortcomings of prior systems, a staffing and expense tracking system, constructed according to the present invention, provides a plurality of users with the ability to access the system via the Internet. The staffing application server (SAS) system resides upon at least one computer server coupled to the Internet and that supports access from computer systems, web-enabled telephones, personal data terminals, and other enabled devices. The SAS system may therefore be accessed from both wired and wireless devices. In one embodiment, users employ browser software to access the SAS system. This approach is advantageous in that it requires no specialized client software.

The inventive system contemplates two general types of user interactions with the SAS system. The first type of user interaction is one that enables a user to his or her (or its) data entered within a SAS system. More particularly, employers and employees access the SAS system to enroll as a prospective employer or as staffing personnel. By way of example, a hospital may establish an account with the SAS system to define payment terms for reimbursing a SAS system operator for the services of staffing personnel. Staffing personnel may establish an account with the SAS system to define his or her qualifications, obtain necessary certifications, and/or define financial information and identification data for proper payment for services rendered. For example, if the staffing personnel is a nurse with specific certifications and experience levels, such information is provided to the SAS system so that the personnel may be considered when an appropriate staffing request is posted by the employer organization.

In order to support the many and varied needs of companies using the SAS system, the SAS system supports configurable graphical user interfaces (“GUIs”). GUIs are those displays provided to users of the SAS system when the users access the SAS system. Via the GUIs, the users input their time and expense records. The GUIs are configurable to alter the objects presented, layout of the objects and information presented, color schemes presented, staffing or expense tracking information required from the user and any other way that cause the SAS system to be more effective. For example, an employer may specify by way of the GUI screens the types of experience and certifications, typical or average performance ratings, salary requirements, desired shift information and other similar types of specifications. Staffing personnel, on the other hand, may specify wage rates in relation to specific shift or specific practice locations or conditions, a maximum number of hours to be contacted in a week, days he or she is not available, preferred days for working, etc. Finally, the system is particularly advantageous to the staffing personnel because the SAS system is less likely to disregard times that the staffing personnel is not willing to work in contrast to many current systems.

GUIs may be customized on a company-by-company basis, department-by-department basis, group-by-group basis, project-by-project basis, user-by-user basis or upon some other known basis. A single SAS system may be used to service the staffing needs of a plurality of companies, each of which has a plurality of divisions, departments, groups and employees/contractors. Thus, the configurability of the SAS system allows differing GUI presentations to be created and presented such that each group of users is employing a different system.

The SAS system also generates GUIs depending upon the type of terminal from which a user accesses the SAS system and the connection over which the user accesses the SAS system. A GUI created for the user when the user accesses the SAS system from a palm-top computer is much simpler than a GUI created for the user when the user accesses the SAS system from a desktop computer. Further, when the user accesses the SAS system from a wireless device, the bandwidth of the available data path from the SAS system to the user's terminal will also be considered. A less complex GUI will be created and provided to the user when lesser bandwidth is available over which to transmit the GUI to the user. This operating feature is particularly important when the user accesses the SAS system from a wireless device.

### BRIEF DESCRIPTION OF THE DRAWINGS

A better understanding of the present invention can be obtained when the following detailed description of the preferred embodiment is considered with the following drawings, in which:

FIG. 1 is a functional block diagram of a computer network that illustrates a staffing application system according to one embodiment of the present invention;

FIG. 2 is a functional block diagram of an application server according to one embodiment of the present invention;

FIGS. 3A through 3E are typical GUI screen displays that illustrate staffing personnel screen displays according to one aspect of an embodiment of the present invention wherein, for exemplary purposes, the employer is a hospital and the staffing personnel is a nurse;

FIGS. 4A through 4C are typical GUI screen displays that illustrate employer screen displays according to one aspect of an embodiment of the present invention wherein, for exemplary purposes, the employer is a hospital and the staffing personnel is a nurse;

FIG. 5 is a flow chart that illustrates system operation according to one aspect of an embodiment of the present invention;

FIG. 6 is a functional block diagram of an SAS system formed according to one embodiment of the present invention; and

FIG. 7 is a flow chart that illustrates a method for finding and placing an employee to satisfy an open request for employees by an employer according to one embodiment of the present invention.

### DETAILED DESCRIPTION OF THE DRAWINGS

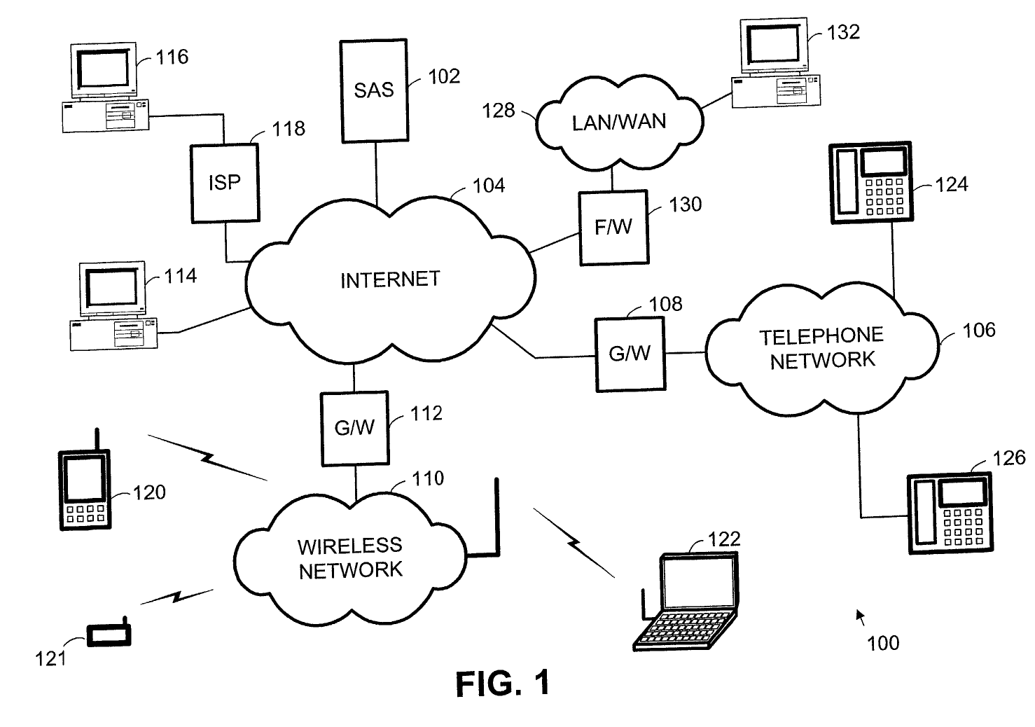

FIG. 1 is a system diagram of a computer network illustrating the operation of a staffing application system 100 constructed according to the present invention. Generally, a staffing application server (SAS) 102 couples to the Internet 104 (World Wide Web or other data packet network) and converses with all other devices using one or more packet switched protocols supported by the Internet 104. A telephone network 106 (which may be a public switched telephone network “PSTN” or other telephone network) couples to the Internet 104 via a gateway 108. Further, a wireless communication network 110 couples to the Internet 104 via a gateway 112. The manner in which the Internet 104 (or other packet switched network) couples to the telephone network 106 and to the wireless communication network 110 is generally known.

Thus, the interaction between the Internet 104 and the other networks 106 and 110 will be described only as it relates to the present invention. The structure and system illustrated in FIG. 1 is for exemplary purposes only. Other structures or networks with different topologies regarding support staffing operations may be constructed according to the present invention. For example, the PSTN network may also be formed in part or completely by an Internet-based telecommunication network. Soft switch voice over IP systems, for example, are currently under design and being implemented in conjunction with the present invention.

Generally, the present invention includes SAS 102 that is for communicating with employers and staffing personnel to create a match therefor, for a short-term staffing arrangement. While the present invention is described in terms of short-term staffing requirements for employers, it is understood that it may be used for permanent placement as well. Moreover, while specific descriptions of the present invention and examples thereof will include a discussion on how the present invention may operate in a health care environment, it is understood that the present invention may be used in a wide range of employment situations. In summary, it may be used in any situation wherein an employer seeks to fill an employment need by way of an automated system coupled to the World Wide Web or other network.

More specifically, computers 114 and 116 couple to the Internet 104 and may interact with the SAS 102 through their connections. While computer 114 has a direct connection to the Internet 104, computer 116 must access the Internet via an Internet Service Provider (ISP) 118. Many users currently access the Internet via an ISP, as illustrated with the connection for computer 116. However, some computers currently access the Internet via an Intranet or other coupling network. In this construction, an ISP may not be required. The structure illustrated in FIG. 1 provides a platform of operation for the present invention only and should not be constructed to limit the teachings of the present invention.

Web-enabled telephones 124 and 126 couple to the telephone network 106. These telephones 124 and 126 each have displays upon which a GUI may be presented to the user. The telephone network 106, as was previously described, may be the PSTN, which transmits data in a PCM format. In another embodiment, the telephone network 106 may be a packet switched network that supports packet-based communications. The teachings of the present invention, therefore, apply equally well to current and future telephone network technology.

Wireless devices 120, 121 and 122 connect to the wireless communication network 110. The wireless communication network 110 may be cellular-based, satellite-based or otherwise structured to provide wireless communication service within a service area. Wireless device 122 is a portable computer that services communications over a wireless link to the wireless communication network 110. Wireless device 120 is a personal data assistant that wirelessly communicates with the wireless communication network 110. While not specifically shown herein, wireless access terminals for new wireless data packet networks (e.g., networks being developed under the 1xEVDO standards) may be used to bridge a connection between a user device (e.g., a laptop computer) and Internet 104.

Wireless device 121 is a two-way pagers that enables staffing personnel to receive a page with a staffing request with employment details. Wireless device 121 further enables the staffing personnel to respond with an indication as to whether he or she wishes to fill the position described in the message that was received.

The invention herein is not limited to the type of wireless device used. For example, the staffing personnel may be contacted by way of a two-way pager, regular cellular phone or one with short message service capability, wireless personal digital assistant, portable personal computer with a wireless modem, etc. The wireless network 110 communicates with the Internet 104 via a gateway 112.

A local area network/wide area network (LAN/WAN) 128 couples to the Internet 104 via a firewall 130. At least one computer terminal, e.g., computer 132, couples to the LAN/WAN and may communicate with the SAS 102 via the LAN/WAN 128 and the Internet 104.

The SAS 102 may be operated by a single company or a plurality of companies that use the SAS 102 to support staffing and/or expenses. Alternately, the SAS 102 may be operated by an application service provider (ASP) that facilitates staffing placement on a short-term or long-term basis for a plurality of customers. The staffing services provided by the ASP may be bundled with other services so that the ASP provides a suite of services to its customers. Additionally, it is presently contemplated to implement the SAS 102 in a manner that provides seamless scalability.

According to the present invention, a plurality of users accesses the SAS 102 via differing communication paths and terminal devices. Staffing information on the part of employers, as well as staffing personnel, is uploaded from the terminal devices to the SAS 102 where it is stored and later used to generate and fill posted openings, as well as generate corresponding invoices, paychecks, reports, and other alternate records. Because the SAS 102 is accessible from any location having Internet 104 access, the SAS 102 provides ubiquitous service worldwide.

Thus, the SAS 102 system services distributed workforces as easily as it does centralized work forces. For example users at terminal devices 120, 132, 126 and 116 may enroll with a single SAS system and may wind up working for a single employer/contractor at differing physical locations. However, in requesting staffing positions or personnel, according to whether the user is an employer or an employee, they simply access the SAS 102 via respective network connections.

A single user may use multiple and differing terminal devices to access the SAS 102. Because of this, the user is not precluded from entering his or her staffing request (either from the perspective of an employer or a staffing personnel) from a single terminal device. While the user is traveling, he or she may use a portable computer 122 to enter a staffing request, or a personal data assistant 120 to respond to a request. Thus, as compared to prior staffing systems, the SAS 102 provides a centralized service environment that is not limited by the user's equipment and does not require multiple phone calls. Further, it enables advanced planning between employers and short-term staff personnel in those situations in which a need can be forecasted.

The design of the present invention is particularly advantageous in that it allows an employer seeking to acquire the assistance of staff personnel to monitor staffing requests in a real-time manner. Stated differently, by omitting a staffing agency from the middle of the transaction between the employer and the staffing personnel, and by using a centralized ubiquitous system, an employer may monitor responses and properly gauge if the salary compensation is adequate to elicit responses from staffing personnel. Moreover, the system includes the flexibility of allowing an employee (user) to enter staffing availability in advance of a need arising.

With respect to graphical user interface features of the invention, a GUI screen for a user of a wireless device 121, for example, may have separate objects for accepting or rejecting an offer of short-term employment. For example, SAS 102 may be programmed to generate differing types of screens according to the type of communication device employed by the staffing personnel or employer for communicating with the SAS 102. The corresponding GUI screen displays then are used to describe a specific employment assignment and enable the staffing personnel to actively accept or reject the short-term offer of employment.

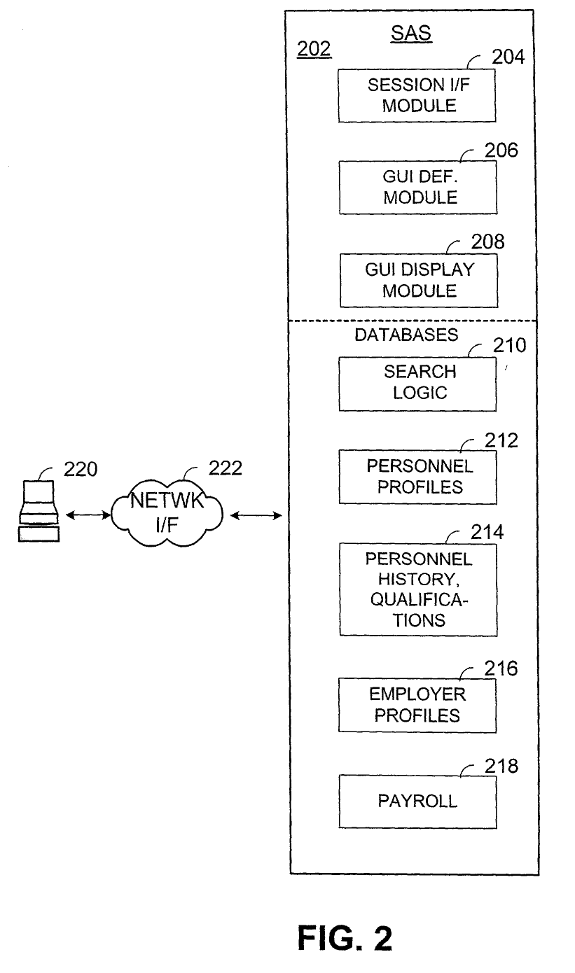

FIG. 2 is a functional block diagram of an application server according to one embodiment of the present invention. A client terminal communicates with SAS 202 by way of the various communication paths described in FIG. 1. SAS 202 thus includes communication protocol information for communicating over the various communication paths in a session interface module 204. Additionally, SAS 202 includes the capacity to store and process the enrollment information entered by the employers and staffing personnel, as well as additional certification information about both (if required) in response to posted employment requirements entered by the various employers.

SAS 202 comprises a session interface module 204, a GUI definition module 206 and a GUI display module 208. Each of these modules operates in concert to support the disclosed invention herein. To illustrate, GUI definition module 206 is for storing default GUI page parameters and GUI display definition information for creating GUI pages on a user terminal display. Additionally, GUI definition module 206 includes information for defining logic for rearranging, renaming, adding and deleting staffing personnel shift requirements. The shift requirements may be entered in a manner in which the staffing personnel may specify required compensation on a per-shift basis. Accordingly, if an employer is sufficiently desperate, the employer will know the staffing personnel's requirements before being contacted for work. Thus, for those shifts that the staffing personnel is not particularly interested in unless a certain wage is offered, the SAS system only contacts the staffing personnel if the employer is willing to satisfy those terms. The specific logic contained therein is better explained in the discussion of the figures that detail operation of the invention.

The inventive system is operable to enable a user to customize the GUI displays to a degree not seen in other display systems and, more particularly, in SAS systems. To enable the user to select display parameters, the inventive system includes a GUI display module 208 that creates GUI displays according to the definition information stored in GUI definition module 206. Additionally, GUI display module 208 includes logic for creating displays according to the display parameters selected by the user that are stored within internal databases.

The databases that are coupled to SAS 202, or are formed within SAS 202, includes one or more databases for storing search logic 210, personnel profiles 212, personnel history and qualifications 214, and employer profiles 216. These profiles collectively drive the search results and SAS 202 operations. As is known by those skilled in the art, SAS 202 may be formed through traditional means that includes a processor, a memory, an internal bus and a network port. Typically, the internal processor executes computer instructions that are defined within the memory according to operational logic defined by the computer instructions. As a part of executing specific process steps stored within the memory, the processor further operates upon data stored within the memory. Thus, the server, as formed, includes computer instructions that cause the server to operate in the manner described in the methods discussed herein.

Alternatively, other known technologies may be utilized to achieve the inventive operation. By way of example, application specific processors may be formed to implement the logic described herein.

The specific operation is influenced by user terminal capabilities, as mentioned herein. By way of example, a user may want to define multiple GUI pages for display on his or her terminal screen according to the terminal type. If the user, for example, typically accesses the SAS system either with a personal data assistant (PDA) or desktop computer terminal, the display capabilities will vary according to the capacity of the terminal in terms of bandwidth, memory and display processing throughput capacity. Accordingly, employer profiles 216 is formed to include software instructions and memory capacity to store multiple GUI display pages according to user need, and GUI display module 208 is formed to include logic for selecting between the multiple GUI pages. Thus, the user may specify the types of GUI pages that are generated according to the type of user terminal being used to access the SAS system.

Session interface module 204 is for determining the terminal type through which the user is accessing the SAS 202. More specifically, session interface module 204 includes software instructions or otherwise defines logic for determining the bandwidth and terminal type of the user terminal. The session interface module 204, in one embodiment, produces a GUI selector signal for the GUI display module 208 to determine what GUI display is to be created for the user terminal 220 that is coupled to SAS 202 by way of network interface 222.

There are many different ways in which the session interface module 204 may generate display types that correspond to the user terminal type. For example, it may roughly determine user terminal data capacity by its response characteristics, including response time, user selection of display type or the user specifying the user terminal type.

In addition to the above modules, SAS 202 further includes a payroll module 218. Payroll module 218 serves to determine what hours were worked by the staffing personnel and the rate of compensation for the staffing personnel for those hours. As has been mentioned already, the compensation in the present system is determinable on a per-shift basis according to terms specified by the employer and the staffing personnel. Accordingly, payroll module 218 calculates the corresponding payment. Additionally, payroll module 218 examines the employee profiles to determine payment particulars, including direct deposit account information, whether the payment is a 1099 type of contract payment or whether taxes should be withheld for the staffing personnel as a direct employee. Additionally, payroll module 218 determines whether any benefits accrue, such as vacation credits, to the staffing personnel based upon the hours worked.

In operation, a user connects to SAS 202 with terminal 220 to respond to employment offers. Session interface module 204 may determine, for example, the user terminal type by sending a message to prompt the user to select a GUI display page type or mode. The GUI display module 208 then builds and transmits a GUI display page based upon the GUI selector signal value created by the session interface module 204 and the user-specific GUI page information stored within employer profiles 216. The SAS 202 further monitors the staffing personnel's hours worked and keeps a history within an internal database. By way of example, the history may be stored in relation to the personnel profiles module 212. Additionally, for each employer rating received for a personnel's performance on a shift (or series of shifts), such rating is stored for future recall and evaluation should an employer specify a minimal rating for the staffing personnel.

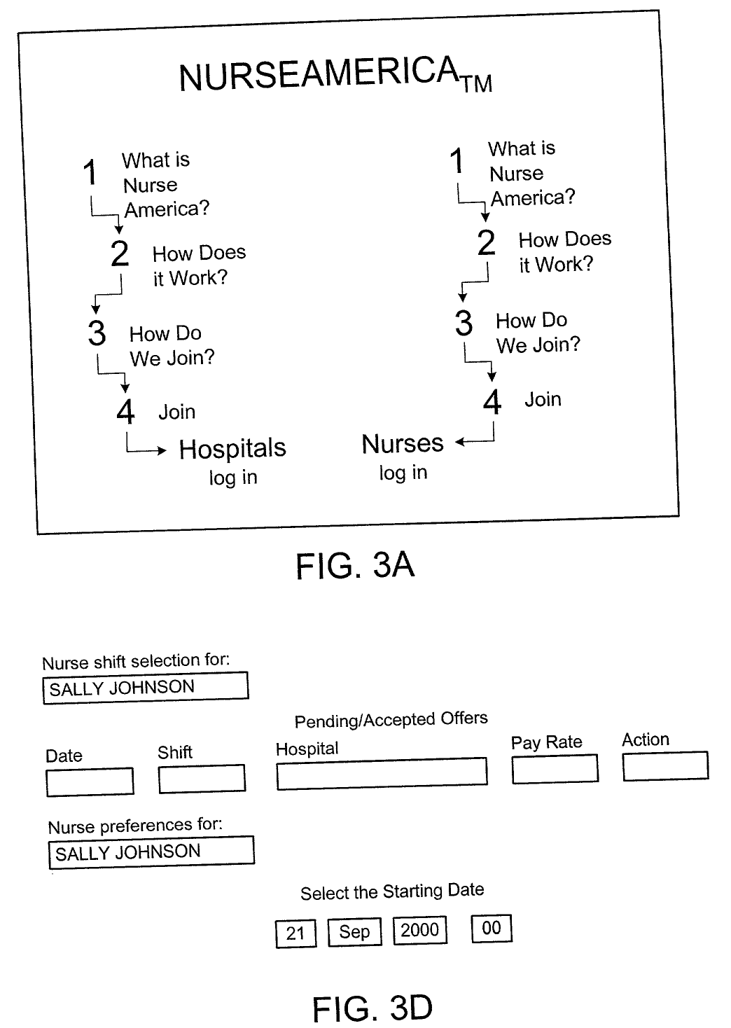

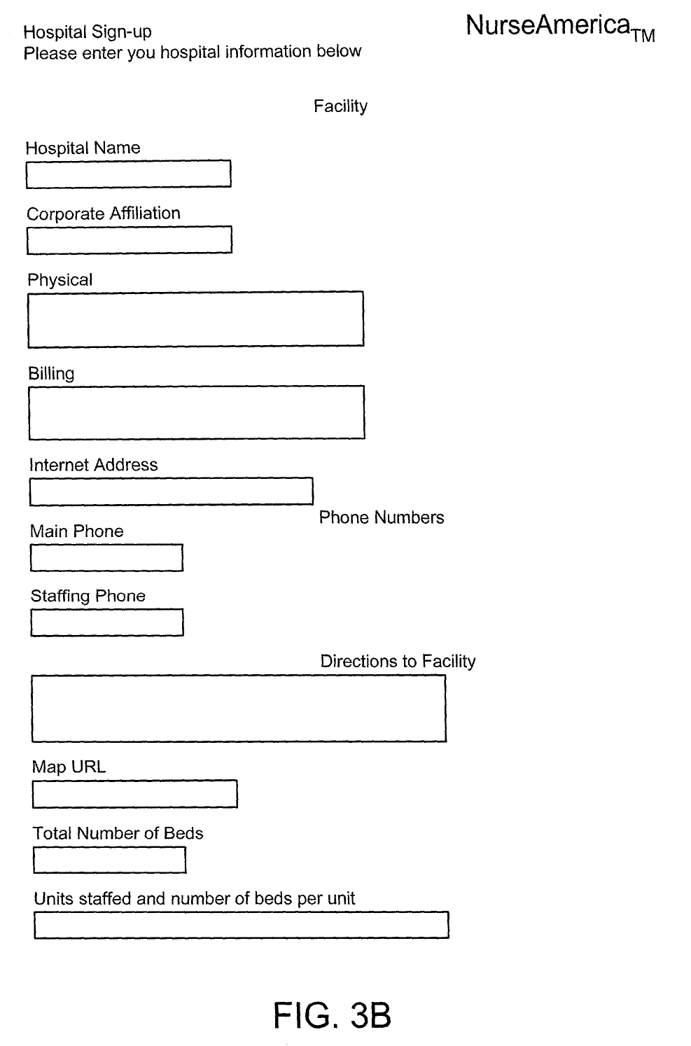

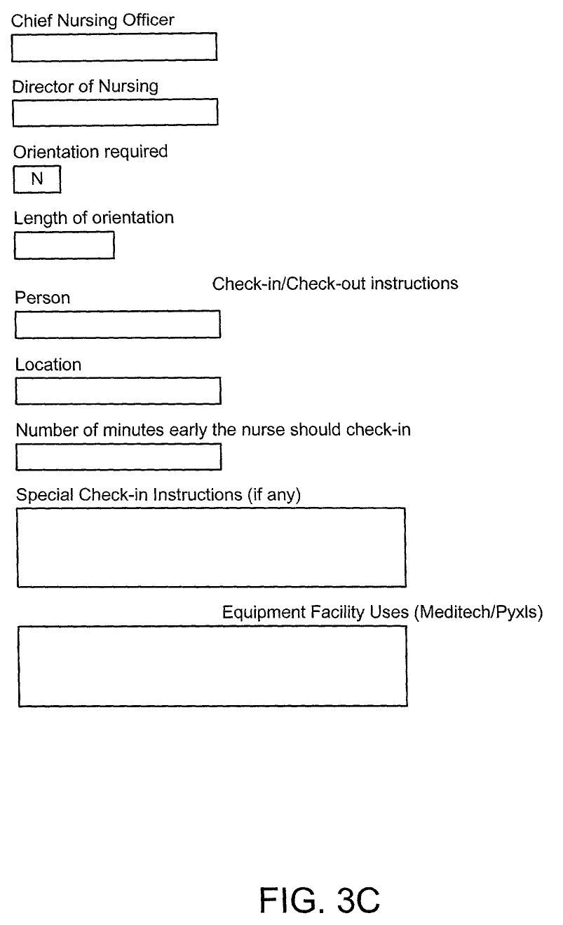

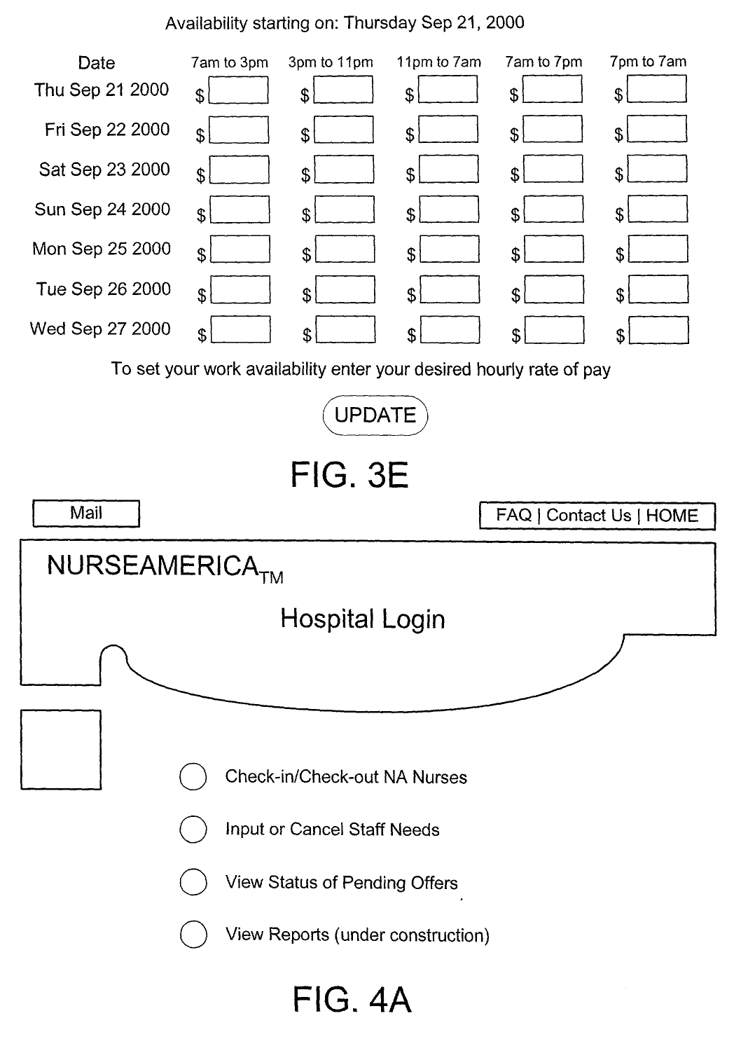

FIGS. 3A through 3E are typical GUI screen displays that illustrate staffing personnel screen displays according to one aspect of an embodiment of the present invention wherein, for exemplary purposes, the employer is a hospital and the staffing personnel is a nurse.

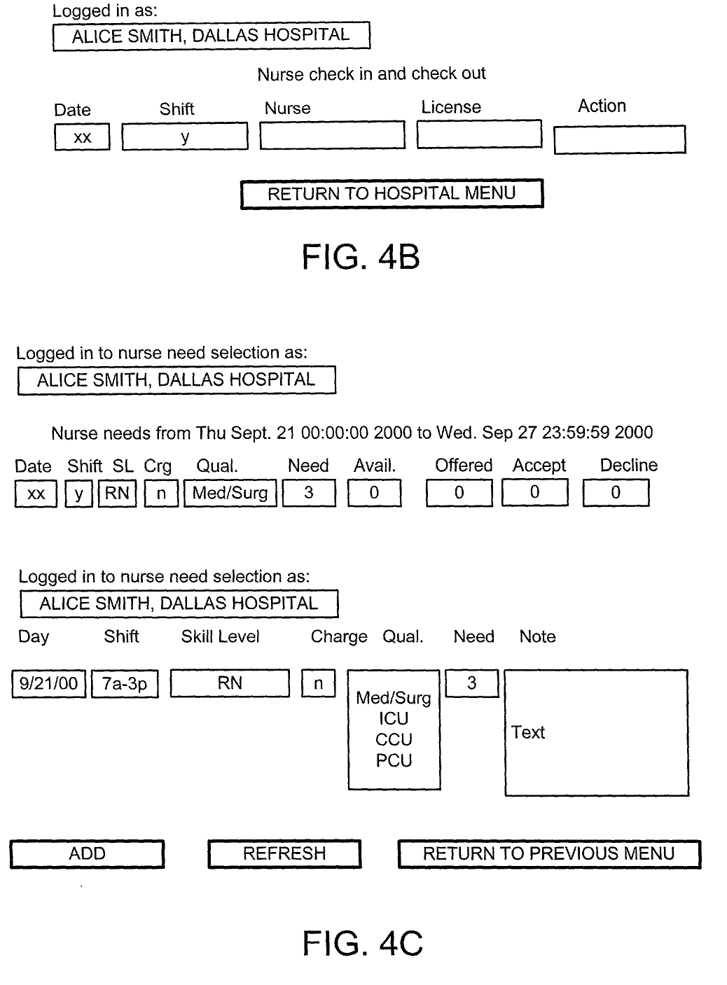

FIG. 3A is a GUI screen display illustrating a home page that is accessed by the general public and provides information about the SAS system implemented by the SAS system operator. For exemplary purposes, FIGS. 3A-3E and 4A-4E illustrate one particular embodiment of the present invention when implemented in the healthcare field. As may be seen, GUI buttons are provided on the home page of FIG. 3A to enable an individual to obtain information, join, request staffing personnel (employer) or specify shift requirements (staffing personnel).

FIG. 3B illustrates a GUI screen display for a hospital (employer) to enter enrollment information, including directions, hospital (employer) description, URL to a map (e.g., Mapquest™), and other descriptive parameters.

FIG. 3C illustrates a second GUI screen display for a hospital (employer) to enter additional enrollment information. By way of example, management information is requested, as well as specific requirements, such as the amount of lead-time necessary for staffing personnel to observe when arriving for a shift. The GUI screen further prompts the hospital (employer) to specify the types of equipment used for those situations where certain skills and/or equipment experience is required.

FIG. 3D illustrates a GUI screen that is for access by the staffing personnel (here, Nurse Sally Johnson) for determining what pending offers for staffing have been accepted. Additionally, the GUI screen of FIG. 3D enables Nurse Johnson to specify her preferences.

FIG. 3E illustrates a GUI screen for staffing personnel to determine specific shifts for which the personnel will be available and the corresponding prices. As may be seen, the staffing personnel have the ability to specify different prices for the different shifts. Thus, by way of example, if Nurse Johnson is normally willing to work for $25 per hour during 7 am to 3 pm Monday through Friday, but wants to be paid $40 per hour on Saturdays and $50 per hour on Sundays, she is able to specify those requirements.

In operation, the SAS system first determines what staffing personnel are available for a specified shift. Thereafter, the SAS system examines the contents of screen 3E for the specified shift for each of the staffing personnel and ranks them according to specified ordering rules. For example, one ordering rule suggested by FIG. 3E is price. Accordingly, the SAS system might, in one embodiment, order the available nurses from least to most expensive for the given shift. Once a certain price threshold is crossed, the SAS system notifies a specified management individual to obtain approval prior to contacting the remaining available staffing personnel. Other ordering rules also come in to play, as will be explained elsewhere. By way of example, other ordering rules include qualifications, certification ratings, performance ratings, etc.

FIGS. 4A through 4C are typical GUI screen displays that illustrate employer screen displays according to one aspect of an embodiment of the present invention wherein, for exemplary purposes, the employer is a hospital and the staffing personnel is a nurse. More specifically, FIG. 4A illustrates a GUI screen of a hospital login screen. As may be seen, the GUI screen of FIG. 4A enables the employer (hospital) to view the status of pending offers, input or cancel posted staffing requirements and to examine the credentials of staffing personnel (nurses).

FIG. 4B illustrates that a hospital may also determine the status of a specific nurse, for example, whether she has checked in for her shift or not.

FIG. 4C is an exemplary screen in which the employer specifies the necessary credentials for the specific shift staffing personnel is desired. For example, an employer (hospital) specifies the day, shift time, required skill level, whether the position is one of a managerial caliber (e.g., a head nurse for a given skill type) and specific qualifications such as ICU, CCU, PCU, etc. Finally, the employer may specify the number of required personnel having the defined requirements. Additionally, the employer may specify any other items by describing such in the note field.

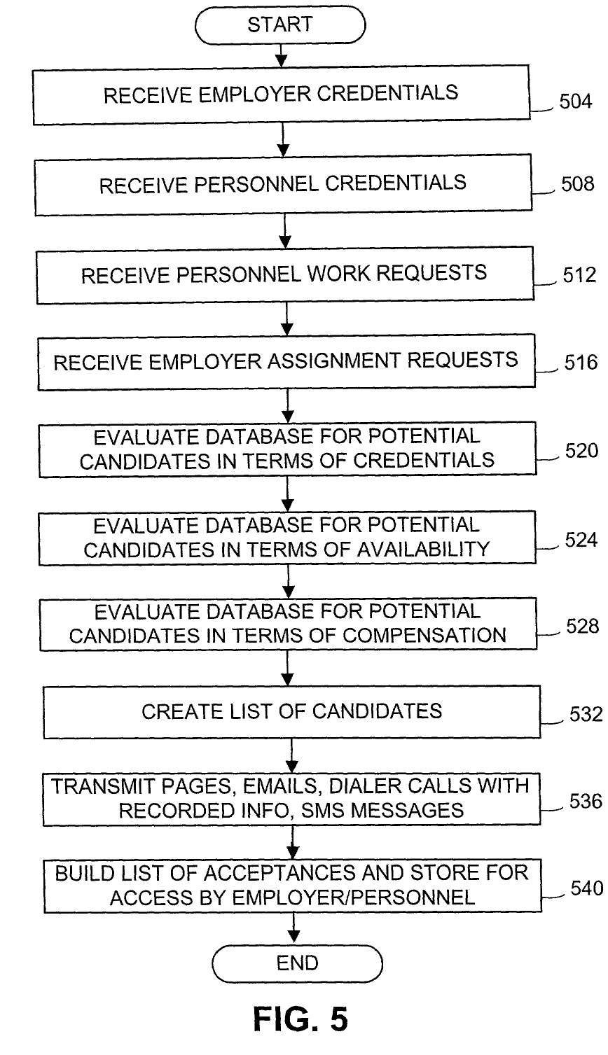

FIG. 5 is a flow chart that illustrates system operation according to one aspect of an embodiment of the present invention. Referring now to FIG. 5, an inventive SAS system initially receives employer credentials and other requisite information, including billing and payment information (step 504). The SAS may receive the employer credential information online through a network port in a preferred embodiment of the invention. The information may also be received by keyboard entry, disk, scanned documentation or other data input mechanism. Similarly, the SAS also receives staffing personnel credentials (step 508). These credentials may also be received by keyboard entry, disk, scanned documentation or other data input mechanism. Finally, the SAS receives personnel work requests (step 512) and employer assignment requests (step 516).

Upon receiving the employer assignment (staffing) requests, the SAS evaluates its internal database(s) to create a list of staffing personnel that are potentially available to fill the posted assignment request (step 520). More specifically, the SAS evaluates the selected schedules to determine which personnel are potentially available for the staffing request (step 524). Thereafter, the SAS evaluates the created list of potentially available staffing personnel to determine the expected compensation of each personnel in comparison to the compensation rate specified by the employer (step 528).

Thereafter, optionally, the SAS reduces the list to those personnel whose compensation requirement is less than or equal to the amount specified by the employer (step 532). In one embodiment of the present invention, the list of candidates is ordered according to compensation amount required (lowest to highest), skills and certifications, total related work experience and, finally, performance appraisal ratings. In another embodiment, the list is selected according to credentials (certifications, skills, experience, etc.) and then ordered according to price. Additionally, in one embodiment of the invention, the list also is selected according to specified shift availability. This particular feature is advantageous in that the staffing personnel will not be contacted for those shifts in which they have indicated they are not available to work. In yet another embodiment, the list also is selected according to whether the stated compensation by the employer is equal to or greater than the minimal compensation defined by the staffing personnel.

Thereafter, the SAS transmits pages, e-mails, dialer calls with recorded information, short message service messages and/or other types of messages to inform the staffing personnel of the staffing position that is to be filled (step 536). Inone aspect of the present invention, the SAS generates messages to two-way pagers to enable the paged recipient to immediately see the description of the posting, including the time, place and compensation amount, and to immediately respond with a commitment or rejection of the offer. For example, with a two-way pager, the personnel may be instructed to enter a “1” to accept the offer of employment for the specified shift, or a “2” to reject it. To the extent other types of technologies are used to contact the staffing personnel, other schemes of providing feedback to the SAS may be employed.

Finally, the inventive method includes tracking the list of acceptances and storing it for display to the employer as requested over the World Wide Web or the network of choice (step 540).

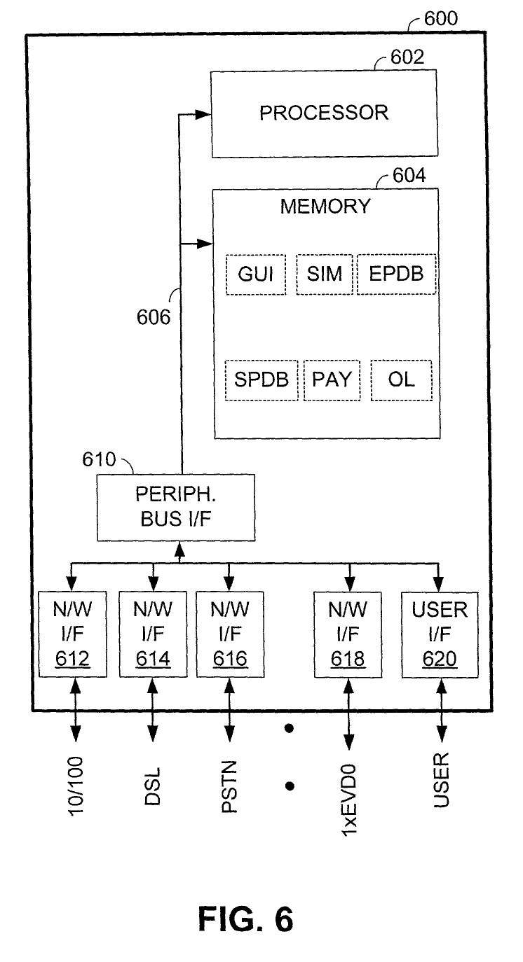

FIG. 6 is a functional block diagram of a SAS system formed according to one embodiment of the present invention. Referring now to FIG. 6, a SAS 600 includes a processor 602 and a memory 604 that are both coupled to a bus 606. Bus 606 is further coupled to a bus controller and peripheral bus interface 610. Peripheral bus interface 610 further is coupled to a plurality of interface ports for communicating with any one of a plurality of different types of systems. In the example of FIG. 6, five different ports 612, 614, 616, 618 and 620 are shown for communicating with anyone of a plurality of different systems or mediums. By way of example, port 612 may be used for communicating over a 10/100 Ethernet line to a digital subscriber line (DSL) modem. Port 614 may be used for accessing the PSTN for dial-up service while port 616 is used for coupling the SAS to a wireless modem formed to communicate over evolving lxEVDO wireless data packet networks. Finally, port 620, for example, may be used for communicating directly with a user terminal that controls the operations of SAS 600, including its user modes of operation.

Memory 604 is for storing computer instructions that are to be produced to processor 602 for execution. Thus, the computer instructions define the operational logic of SAS 600, its modes of operation, its logic units and modules, etc. More specifically, memory 604 includes computer instructions that define the operational logic for the aforementioned session interface module (SIM), employee profile database (EPDB), graphical user interface (GUI) logic, staffing preferences database (SPDB), payroll function (PAY), and, of course, general operational logic (OL) for SAS 600. This list is exemplary and is not intended to be construed as a complete list. Any functionality or its equivalence described herein is and may be included.

Each of the methods described herein, and variations of those methods, are defined by the computer instructions stored in memory 604. In terms of hardware, memory 604 can comprise any type of known volatile and permanent memory, including hard disk drives, floppy disk drives, DVDs, various types of read only memory and random access memory.

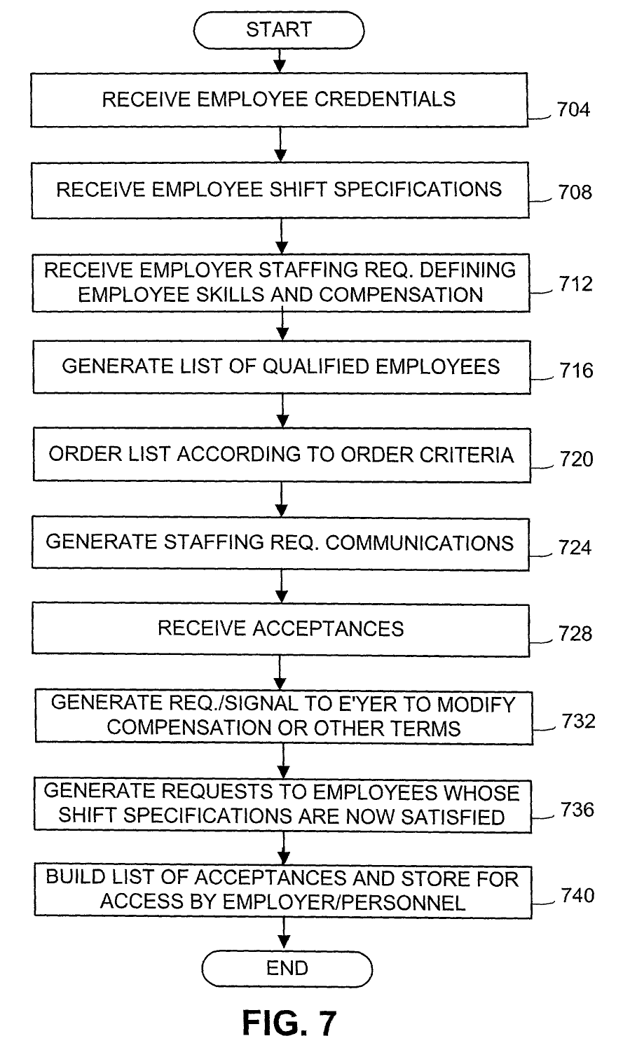

FIG. 7 is a flow chart that illustrates a method for finding and placing an employee to satisfy an open request for employees by an employer according to one embodiment of the present invention. Referring now to FIG. 7, a server initially receives employee credentials and stores them in memory in a specified format (step 704). In the described embodiment, employee credentials are stored in a database that may be searched to satisfy employer open requests for staffing. The server further receives employee shift specifications (step 708). Examples of shift specifications include salary, location, distance, and shift length requirements. In the described embodiment of the invention, the requirements may be specified on a per-shift basis. For example, an employee may not be willing to work in a certain geographic area because of weekday traffic concerns but may be willing to drive to such a location during a weekend or holiday when traffic is lighter. Additionally, the employee, in the described embodiment, may specify salary requirements on a shift basis or even based upon location.

The server also is formed to receive employer requirements or specifications for the employees (step 712). For example, a hospital may require training at certain types of facilities and schools as a permanent requirement. Additionally, the server is formed to receive and process requirements that pertain to a specific shift or open request for staffing. The employer requirements further include a definition of the skills, certifications and types of training the prospective employees have to possess.

Once the server receives a request for staffing, it then examines the contents in memory (in its database, for example) to generate a list of potential employees that are qualified according to the employer's permanent requirements and its requirements that relate to the open staffing request (step 716). Once the list is generated, the server orders the list according to specified ordering requirements of the employer (step 720). Many factors may be used to prioritize and order the list of employees, including compensation requirements and amount of experience. In one embodiment of the invention, the memory of the server further stores employer reviews of job performance (employee ratings) and thus the server orders the employees according to average job performance ratings. For this embodiment, un-rated employees are given lower priority and are listed later in the ordered list of employees.

Once an ordered list is processed, the server generates staffing request communications to the employees according to the position on the ordered list (step 724). The communications occur in any one of the many different ways defined herein and as specified by the employee in his or her stored profile listing shift specifications.

Once the communications have been generated, the server begins receiving acceptances (and possibly rejections) from the various employees being contacted (step 728). After responses have been received for all requests that have been transmitted, the server automatically generates a request to the employer if there still exist open positions that are not filled and request what further steps are to be taken (step 732). For example, in the described embodiment, when an open staff request is generated, the server requests a pay increase to increase the number of potential employees available to work during the specified shift(s). The invention also includes generating communications to employees whose shift specifications became satisfied with a change in shift requirements by the employer, including compensation for the shift (step 736). Finally, the inventive process includes building a list of acceptances for access by the employers and employees (step 740). It is understood, of course, that the employers and employees level of access to the information and statistics are modifiable according to a level of access permissions granted to the party seeking access to the information.

The inventive method and apparatus disclosed herein is are particularly advantageous in that they provide a capability for improving the ability of employers and staffing personnel to make short-term arrangements in an improved manner. More particularly, the present invention reduces overhead associated with funding nurse payroll. The SAS digitally invoices hospitals and pays nurses in a real-time manner. Profits are realized immediately for the SAS system operator, allowing the company to operate on much lower margins which translate into direct savings to the employer and more pay for the staffing personnel.

The present inventive system does not require the staff associated with scheduling such as that of a traditional temporary staffing agency. Because the SAS system creates an approach that is automated and requires no phone solicitations to schedule a shift, process efficiencies are realized. All communication is generated automatically by web-enabled software of the SAS system and is transmitted digitally via two-way e-mail pagers and other types of wireless and wireline communication systems. This also contributes to lowering overhead expenses, thereby allowing greater savings to the employer and more pay to the staffing personnel.

By utilizing the SAS system, a hospital can save as much as 80 percent over using a traditional staffing agency. Given that the present invention may be applied in a healthcare arena where short-term staffing needs are continuous and difficult to fill, the present invention will facilitate the ability of hospitals to manage and effectuate short shift staffing by nurses, as well as physicians, of specific types. The present invention also provides a cost effective and efficient way to manage permanent and temporary core staff within a hospital in addition to the temporary shift staffing.

Because the present invention provides significant automation of a previously manual process, less effort will be required by core hospital employees in sourcing nurses through the inventive SAS system rather than through the traditional staffing approach. Because the system is managed quickly and easily via the web, it is possible for the existing shift or floor supervisor in the hospital to manage his or her own scheduling matrix. Over time, this will result in a reduction in internal staff required to manage supplemental pools of nurses.

The SAS system can provide many advantages that may be realized in numerous other fields as well. As is described herein, its use in a hospital environment illustrates advantages such as less expensive access to national pools of supplemental nurses, seamless management and communication of core staff scheduling, employment and assumed responsibility for all personnel, background checking and verification of competencies of all personnel, monitoring of date-sensitive information relating to medical staff employment, paying all federal and state tax liabilities of medical personnel, monitoring all overtime pay and liabilities, real-time needs and usage reports, and real-time market information on pay rates and availability.

By way of example in the nurse services field, advantages include access to the NurseAmerica (???????) staffing solution, complete professional autonomy, real-time career advancement, payroll direct deposit, checking account for direct deposit of payroll (when applicable), 401K, a national, two-way, e-mail pager, access to discounted continuing medical education, access to discounted continuing education units and monitoring and access to discounted advanced practice certifications.

The present SAS system may realize 60% to 80% cost savings compared to traditional alternatives. To date, there are no similar services. This advantage is due to savings on cost of staff, ease of implementation and use, no risk to entry and the ability to use the system without a learning curve.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed. On the contrary, the invention is intended to cover all modifications, equivalents and alternatives falling within the spirit and scope of the present invention as defined by the claims. For example, the present invention may be formed within a server that is utilized for filling internal job postings, or as described herein, for filling postings between temporary and permanent staff personnel and one or more employers. As may be seen, the described embodiments may be modified in many different ways without departing from the scope or teachings of the invention. For example, any combination of the described methods may be combined to create an inventive system that facilitates staffing placement in an efficient manner that satisfies employer and employee requirements. Moreover, the system is advantageous in that it allows a degree of flexibility not seen heretofore by enabling one to specify compensation and other usually non-variable requirements on a per-shift basis.

1. A staffing application server for facilitating the filling of short-term staffing requirements, comprising:
circuitry for receiving employer and staffing personnel enrollment data;
circuitry for receiving employer staffing requirements; and
circuitry for receiving staffing personnel participation data, the participation data comprising shift availability and compensation requirements wherein the compensation requirements are made with respect to specific shifts.

2. The server of claim 1 wherein the compensation requirements are specified with respect to specified shift information data in a staffing personnel profile record.

3. The server of claim 2 wherein the server includes logic for creating a list of staffing personnel that are available for a specified shift and whose compensation requirements are less than or equal to the compensation value that the employer is willing to pay.

4. A method of matching staffing personnel with posted shift work assignments, comprising:
searching at least one internal database to create a list of staffing personnel that can satisfy the requirements for a posted work assignment;
transmitting a message to a text message capable device, the message defining the posted shift work assignment including its compensation; and
receiving a response from the text message capable device, the text message response indicating whether the staffing personnel accepted or rejected the shift offer for the posted shift work assignment.

5. The method of claim 4 further including the step of transmitting the text message to a two-way pager.

6. The method of claim 4 further including the step of transmitting the text message to a cellular phone having short message service capability.

7. The method of claim 4 further including the step of transmitting the message to a user terminal wherein the message is transmitted in the form of an e-mail message.

8. The method of claim 4 further including the step of transmitting the message to a wireless personal digital assistant.

9. The method of claim 4 further including the step of transmitting the message to a voice only device, such as a telephone, wherein the message is converted to voice by an interactive voice response unit.

10. The method of claim 9 wherein the interactive voice response unit provides an aural prompt to the called party to prompt the called party to acknowledge his or her identity as the staffing personnel being called and to enter a first number to indicate acceptance of the offer and a second number to indicate rejection of the offer.

11. A method in a staffing application server of matching staffing personnel to a posted assignment, comprising:
creating a list of potential staffing personnel whose shift and compensation requirements are satisfied; and
ordering the list according to a plurality of factors, including compensation, certifications, experience, performance ratings and total experience, but not necessarily in that order.

12. The method of claim 11 wherein the list is ordered as follows: certifications, experience type, performance ratings, total experience and compensation.

13. The method of claim 11 wherein the list is ordered as follows: experience type, performance ratings, total experience type, compensation and certifications.

14. The method of claim 11 wherein the list is ordered as follows: performance ratings, total experience, compensation, certifications and experience type.

15. The method of claim 11 wherein the list is ordered as follows: compensation, certifications, experience type, performance ratings and total experience.

16. The method of claim 11 wherein the list is ordered first by compensation.

17. The method of claim 11 wherein the list is ordered first by certifications.

18. The method of claim 11 wherein the list is ordered first by experience type.

19. The method of claim 11 further including the step of transmitting messages to potential staff and receiving a signal indicating acceptance.

20. The method of claim 19 further including sending a signal to an employer for the posted assignment to indicate whether all staffing needs have been met.

21. The method of claim 20 further including the step of increasing the compensation amount for the posted assignment and sending messages to potential staff that are now available for consideration for the posted assignment.
